(19) United States
(12) Patent Application Publication
(10) Pub. No.: US 2007/0211154 A1
(43) Pub. Date: Sep. 13, 2007

(54) Lens vignetting correction algorithm in digital cameras

(76) Inventors: Hesham Mahmoud, Cary, NC (US); Anastassios Markas, Cary, NC (US); Darryl C. Olivier, Wake Forest, NC (US)

Correspondence Address: SCHNECK & SCHNECK, P.O. BOX 2-E, SAN JOSE, CA, 95109-0005, US

(21) Appl. No.: 11/374,517

(22) Filed: Mar. 13, 2006

(51) Int. Cl. H04N 9/64; G06K 9/40

(52) U.S. Cl. 348/251; 382/274

(57) ABSTRACT

A lens vignetting correction method for use in imaging systems such as digital cameras employs a polynomial correction function F=ar²+br⁴+c, wherein r is a distance to a center of correction. A calibration image is obtained using the imaging system, then the correction function applied to the calibration image is least-squares fit to determine the variable coefficients a, b and c. Subsequent raw images from this imaging system are corrected by applying the correction function thereto on a pixel-by-pixel basis. A recursive technique is used to obtain correction function values for given pixel locations from modification of values for preceding pixel locations.

### TECHNICAL FIELD

The present invention relates generally to digital data processing of pictorial information derived from digital still cameras, digital video camcorders and other camera-like image-sensing instruments, and in particular relates to image enhancement by means of transformations for scaling the pixel intensity values of a captured image as a function of pixel position.

### BACKGROUND ART

Vignetting is an optical phenomenon that occurs in imaging systems wherein the amount of light reaching off-center positions of a sensor (or film) is less than the amount of light reaching the center. This imaging defect causes the image intensity to decrease toward the edges of an image. The amount of vignetting depends upon the geometry of the lens and varies with focal length and f-stop. The effect is more apparent in lenses of lower f-stop (larger aperture), which are used especially in semi-pro/professional still cameras and video camcorders.

A lens vignetting correction algorithm may be applied to a digital image (or digitally-scanned photographic image), or to a series of such images, in order to compensate for the positionally unequal intensity effect of vignetting upon the image. This type of image enhancement or correction generally involves some kind of bitmap-to-bitmap transformation in which image intensity or “gray scale” data for the various picture elements (pixels) are appropriately scaled according to pixel position. Such an algorithm can be implemented in an image processor integrated circuit for use in digital still cameras, digital video camcorders, or any other camera-like image-sensing instrument affected by vignetting.

The particular algorithm and its implementation would preferably achieve optimal anti-vignetting without the need for much extra processing hardware (multipliers, look-up tables, etc.) and with adequate speed and efficiency (especially for real-time image processing). A reasonable set of parameters for the correction formula, and ready adaptability to a variety of lenses, is desirable.

U.S. Pat. No. 6,747,757 to Enomoto describes correction of several types of image errors, including decreasing brightness at the edge of the image field. It is geared especially to film scanners. The correction equation is log E(r)=a₁r+a₂r²+a₃r³. It lacks a recursive approach suitable for real-time digital cameras. Accordingly, it relies upon look-up tables to implement the compensation upon the image data.

U.S. Pat. Nos. 6,577,378 and 6,670,988 to Gallagher et al. describe compensation of respective film and digital images for non-uniform illumination or light falloff at the focal plane, due to factors such as vignetting. A single light falloff correction parameter f₂ is determined, based upon an assumed cos⁴ θ light falloff away from the optical axis. For a given camera type, lens, f-stop and focal length, and any flash device, the parameter f₂ can be found by a least-squares fit using a representative sample of pixel elements pᵢⱼ of a captured image of a scene. Correction parameters specific to each type of camera lens may be stored in a meta-database. With the parameter f₂ known, compensation values are applied to the individual pixels according to the light falloff compensation function for that parameter. Although only one parameter f₂ needs to be determined, the correction calculation itself contains trigonometric functions (cos, tan⁻¹), exponentiation (power of 4), logarithms and division, and is therefore quite complex and in need of extensive processor hardware.

U.S. Patent Application Publication No. 2004/0155970 of Johannesson et al. describes a vignetting compensation method for digital images. The method obtains a 5×5 matrix of coefficients kᵢⱼ (0≦i,j≦4) describing a polynomial surface function g(x,y) representing the relative brightness or vignetting gain at pixel positions (x,y). In particular,
g(x,y)=ΣᵢΣⱼkᵢⱼxⁱy^{j}.
The matrix coefficients kᵢⱼ are estimated by a least-squares fit to the measured intensity data from an image taken of a gray test chart. These coefficients are then stored in a nonvolatile memory. After being normalized, the function g is inverted to create a (look-up) gain table whose pixel-by-pixel multiplication with a raw image will produce a vignette-corrected image. Thus, the method involves both a complexity of computation and the need for look-up tables in order to implement the correction with any reasonable degree of efficiency.

### SUMMARY DISCLOSURE

The present invention is a lens vignetting correction algorithm implemented in image processing hardware and associated software. The correction applied to the image data is a 4^{th}-order polynomial function in polar form with only the three even-order coefficients being non-zero. This function defines a radially symmetric curve that expresses the relative intensity correction to be applied to each pixel as a function of the radial distance of that pixel from a center. The center of the correction curve may vary with the optical alignment of each camera, or may be assumed to be very close to the center of the image. The variable coefficients, possibly camera-specific, may be found by fitting of the image data directly to the polynomial correction function, for example, by a least-squares fitting technique. The algorithm applies the polynomial correction function to the several pixels of the image using an iterative calculation that eliminates the need for extra hardware, such as multipliers or look-up tables.

### BRIEF DESCRIPTION OF THE DRAWINGS

FIG. 1 is a flow diagram of an embodiment of the vignetting correction method of the present invention.

### DETAILED DESCRIPTION

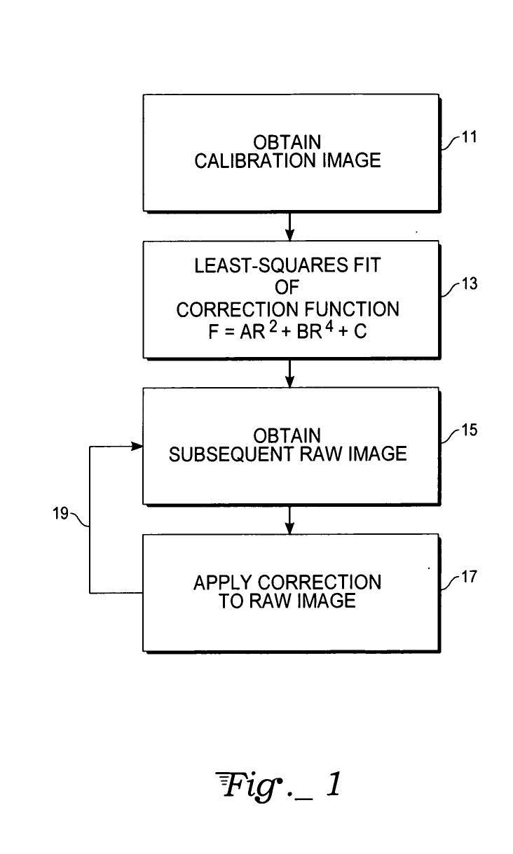

With reference to FIG. 1, the basic flow of a vignetting correction method in accord with the present invention begins with obtaining a calibration image (step 11) using an imaging system, such as digital still camera, digital video camcorder, or other imaging instrument. The calibration image may be that of a uniformly-lit gray surface. However, due to vignetting, the calibration image will exhibit a falloff in intensity away from the image center.

Next, a least-squares fit of the correction function (step 13) is performed. Least-squares (or minimum mean square error) is just one possible technique for fitting the parameters to the imaging characteristics of the optical system. Other fitting techniques could also be used to obtain a set of “best” parameters depending on the optimality criterion used.

For the present invention, the lens vignetting correction function is chosen to be a radially symmetric 4^{th}-order polynomial,
F(x,y)=ar²+br⁴+c,
where (x,y) is the variable pixel position, r is the radial distance from a center (x₀, y₀) of correction,
r²=(x−x₀)²+(y−y₀)²
and a, b, and c are variable coefficients corresponding to the particular imaging system.

The center (x₀, y₀) of correction is usually assumed to coincide with the center (0,0) of the image, so that r²=x²+y². In most cases, the alignment between image and lens is such that this assumption will be sufficiently accurate. However, if alignment between image and lens is not guaranteed, we can generalize to any center (x₀, y₀) of correction.

Applying this correction function F(x,y) to a raw image, we get a corrected image:
P(x,y)=P₀(x,y)×F(x,y),
where P₀(x,y) is the raw captured image and P(x,y) is the corrected image.

If a flat gray calibration object is imaged by the system, then the resulting raw calibration image can be used to find the coefficients, a, b and c, for that particular imaging system. That is, we can assume that applying a correction function F(x,y) with the appropriate coefficients, a, b and c, to the raw calibration image, should obtain a corrected image that is again a perfectly flat gray image, P(xᵢ,yᵢ)=constant.

Accordingly, we choose a fitting technique to obtain a set of coefficients, a, b, and c. Least-squares or minimum mean square error is one such fitting technique that could be used. Others may choose different criteria to obtain a set of “best” coefficients in relation to image data. Applying a least-squares fitting technique, we obtain a metric E²:
E²=(1/n)Σᵢ[P₀(xᵢ,yᵢ)−F(xᵢ,yᵢ)]²,
and find coefficients, a, b and c, of F, such that
{∂(E²)/∂a=0, ∂(E²)/∂b=0, ∂(E²)/∂c=0}.
The threefold criteria may be resolved into a matrix equation P=RA, where:

$$P = [ \begin{matrix}{P}_{0} ( {x}_{0} , {y}_{0} ) \\ {P}_{0} ( {x}_{1} , {y}_{1} ) \\ ⋯ \\ {P}_{0} ( {x}_{N} , {y}_{N} )\end{matrix} ] , A = [ \begin{matrix}a \\ b \\ c\end{matrix} ] , and$$

$$R = [ \begin{matrix}{r ( {x}_{0} , {y}_{0} )}^{2} & {r ( {x}_{0} , {y}_{0} )}^{4} & 1 \\ {r ( {x}_{1} , {y}_{1} )}^{2} & {r ( {x}_{1} , {y}_{1} )}^{4} & 1 \\ ⋯ & ⋯ & ⋯ \\ {r ( {x}_{N} , {y}_{N} )}^{2} & {r ( {x}_{N} , {y}_{N} )}^{4} & 1\end{matrix} ] ,$$

where the elements of the 1×N matrix P are the corresponding values P₀ of the calibration pixels (xᵢ,yᵢ) over the entire calibration image (or a representative sample thereof), where the elements of the 1×3 matrix A are the correction coefficients a, b and c which are sought, and where the elements of the 3×N matrix R are the radial distances r of the calibration pixels (xᵢ,yᵢ) from the center of correction, raised to respective 2^{nd}, 4^{th} and 0^{th} powers. The solution of this matrix equation is known to be:
A=R⁺P,
where R⁺=(R^{T}R)⁻¹R^{T} is the Moore-Penrose matrix pseudoinverse of R, with R^{T} being the matrix transpose of R. R⁺ can be found in advance for a given set of (xᵢ,yᵢ) and a given center of correction. Hence, least-squares fitting of the calibration image to find the correction coefficients (a,b,c) resolves into a relatively simple matrix multiplication.

If the alignment between imager and lens is not guaranteed, such that one cannot assume that the center of vignetting coincides with the center of the image, we can search for coefficients (a,b,c) for different “center” coordinates (x₀ₕ,y₀ₖ), where h and k are variable. The center coordinates that lead to a minimum mean square error (smallest E² value) is then considered to be the center of vignetting, and the coefficients (a,b,c) are those found for that particular center.

After fitting the correction function F, we can use that function to correct subsequent raw images obtained by that imaging system. Accordingly, whenever a raw image is obtained (step 15 in FIG. 1), we apply the correction function F to the raw image on a pixel-by-pixel basis (step 17). That is, corrected image P(x,y)=P₀(x,y)×F(x,y), for each pixel location (x,y). This application of correction function F can be repeated (return step 19) each time a new raw image is obtained.

In order to eliminate the need for extra processing hardware, such as multipliers, and to operate efficiently in real-time, the algorithm that implements the image correction employs a recursive technique for updating r². This technique may proceed as follows:
a, b, c
x0h, y0k
R²[=(x0h)²+(y0k)²]
stepX, stepY
dy:=y0k
r²:=R²
for y=1 to height (step=stepY)
   dx:=x0h
   rx²=r²
   for x=1 to width (step=stepX)
      rx⁴:=rx²*rx²
      F:=rx²*a+rx⁴*b+c
      P(x, y):=P(x, y)*F
      rx²:=rx²+stepX*stepX−2*stepX*dx
      dx:=dx−stepX
   end
   r²:=r²+stepY*stepY−2*stepY*dy
   dy:=dy−stepY
end
   Step Y is usually 1, 2, or 4, depending on the imager interface. Step X is always 2 for Bayer pattern imager output. This means that all multiplications involving the updates of rx² and r² can be implemented by shift operations, which are inexpensive in hardware (or in software.) As seen here, the correction coefficients a, b and c are provided, along with the correction center coordinates (x0h, y0k) for those coefficients. The radial distance squared, R², from this center is also provided for the top-left pixel position of the image. The correction of pixel intensity, P(x,y):=P(x,y)*F, proceeds row by row (incrementing row coordinate y by stepY) from top to bottom, and from left to right within rows (incrementing column coordinate x by stepX) until the entire image has been corrected. Extensive use of exponentiation for each pixel is not required when this recursive technique is used.

The vignetting correction of color images may use separate correction coefficients for each color. Consider the case of a Bayer pattern where each pixel is defined by one of three primary colors (e.g., red, green, and blue), and that uses a two-field interlaced format. Odd-numbered rows or lines 1, 3, 5, . . . may form a field 0 made up of alternating green and red pixels, while even-numbered rows or lines 2, 4, 6, . . . may form a field 1 made up of alternating blue and green pixels. This format may be indicated to the processor, for example, by means of one or more control register bits. Pixels in this particular format are effectively grouped into 2×2-color cells, made up of the primary colors is some defined pattern. For example:
line 1, pixel 0 (L1P0): green pixel;
line 1, pixel 1 (L1P1): red pixel;
line 2, pixel 0 (L2P0): blue pixel; and
line 2, pixel 1 (L2P1): green pixel.
   The green pixels may use one set of correction coefficients (a₀, b₀, c₀), the red pixels may use another set of correction coefficients (a₁, b₁, c₁), and the blue pixels may use yet a third set of correction coefficients (a₂, b₂, c₂) . The coefficients may need to be scaled to fit a specified format, such as 1 sign bit, 3 integer bits, and 8 fractional bits. A register may designate the scale factor to be used. In this example, scaling could set registers to A_L1P0=A_L2P1=a₀-2^{scale}, B_L1P0=B_L2P1=b₀-2^{2·scale}, C_L1P0=C_L2P1=c₀·2, A_L1P1=a₁·2^{scale}, B_L1P1=b₁·2^{2·scale}, C_L1P1=c₁·2, A_L2P0=a₂·2^{scale}, B_L2P0=b₂·2^{2·scale}, and C_L2P0=c₂·2, where the registers store scaled versions of the coefficients used for the various color pixels in the cells. When applying the recursive correction algorithm to the pixels of a particular color, the processor will access these stored scaled coefficients from the appropriate registers. The four pixels in each cell might also reference a slightly different center of correction. Similar adaptations can be made for other image interlace types.

What is claimed is:

1. A vignetting correction method comprising:
obtaining a calibration image with an imaging system;
fitting a correction function F=ar²+br⁴+c applied to the calibration image, wherein r is a distance of an image pixel to a center of correction, and wherein a, b and c are variable coefficients found through the fitting;
applying the correction function directly to subsequent raw images obtained with said imaging system so as to produce corrected images.

2. The vignetting correction method as in claim 1, wherein the obtained calibration image is of a uniformly gray calibration object.

3. The vignetting correction method as in claim 1, wherein the fitting is a least-squares fitting.

4. The vignetting correction method as in claim 1, wherein the center of correction is assumed to coincide with an image center.

5. The vignetting correction method as in claim 1, wherein the center of correction is a variable also found through the fitting.

6. The vignetting correction method as in claim 1, wherein applying the correction function comprises a multiplying of correction function values with the pixel intensity data of the raw image for each pixel location.

7. The vignetting correction method as in claim 6, wherein correction function values for the pixel locations are calculated using a recursive modification of correction function values from preceding pixel locations.

8. The vignetting correction method as in claim 1, wherein applying the correction function is performed by image processing hardware on a real-time basis as raw images are obtained.

9. The vignetting correction method as in claim 1, wherein a separate correction function is fit to each distinct pixel color.

10. A vignetting correction method comprising:
obtaining a calibration image of a uniformly gray object using an imaging system;
performing a least-squares fitting of a polynomial correction function F(x,y)=ar²+br⁴+c applied to the calibration image, wherein r²=(x−x₀)²+(y−y₀)² is a distance squared of an image pixel at location (x,y) to a center of correction (x₀,y₀), and wherein a, b and c are variable coefficients found through the fitting;
applying the correction function F(x,y) directly to subsequent raw images P₀(x,y) obtained with said imaging system on a pixel-by-pixel basis so as to produce corrected images P(x,y)=P₀(x,y)×F(x,y).

11. The vignetting correction method as in claim 10, wherein the obtained calibration image is of a uniformly gray calibration object.

12. The vignetting correction method as in claim 10, wherein the least-squares fitting solves a matrix equation A=R⁺P, where A is a 1×3 matrix of the coefficients a, b and c to be found, P is a 1×N matrix of calibration pixel values obtained from the calibration image, and R⁺ is a pseudoinverse of a 3×N matrix R of radial distances r raised to respective 2^{nd}, 4^{th} and 0^{th} powers for the calibration pixel values used in P.

13. The vignetting correction method as in claim 10, wherein the center of correction (x₀,y₀) is assumed to coincide with an image center.

14. The vignetting correction method as in claim 10, wherein the center of correction (x₀,y₀) is a variable also found through the least-squares fitting.

15. The vignetting correction method as in claim 14, wherein the least-squares fitting is repeated with different centers of correction, and a center of correction (x₀ₕ,y₀ₖ) that results in a minimum mean-square error for fitted coefficients a, b and c of F(x,y) is selected as the center of correction used in applying the calibration function to subsequent raw images.

16. The vignetting correction method as in claim 10, wherein correction function values for the pixel locations are calculated using a recursive modification of correction function values from preceding pixel locations.

17. The vignetting correction method as in claim 16, wherein the recursive modification proceeds in uniform incremental steps, row-by-row and pixel-by-pixel within rows.

18. The vignetting correction method as in claim 10, wherein applying the correction function is performed by image processing hardware on a real-time basis as raw images are obtained.

19. The vignetting correction method as in claim 10, wherein a separate correction function is fit to each distinct pixel color.
